(19) United States
(12) Patent Application Publication
(10) Pub. No.: US 2006/0082923 A1
(43) Pub. Date: Apr. 20, 2006

(54) Spindle Motor and Recording Disk Driving Apparatus Having the Same

(75) Inventors: Harushige Osawa, Kyoto (JP); Satoru Sodeoka, Kyoto (JP)

Correspondence Address: JUDGE PATENT FIRM;RIVIERE SHUKUGAWA 3RD FL., 3-1 WAKAMATSU-CHO, NISHINOMIYA-SHI, HYOGO, 662-0035, JP

(73) Assignee: NIDEC CORPORATION, Kyoto (JP)

(21) Appl. No.: 11/163,480

(22) Filed: Oct. 20, 2005

(30) Foreign Application Priority Data
Oct. 20, 2004 (JP) JP-2004-305706
Oct. 18, 2005 (JP) JP-2005-302391

(51) Int. Cl. G11B 17/00

(52) U.S. Cl. 360/97.01

(57) ABSTRACT

A spindle motor and a compact, thin recording disk driving apparatus consuming less power and capable of stable rotation are disclosed. A magnetic head, when accessing a recording disk, is pressed against the recording disk and generates a moment to tilt the rotational axis in a specified direction. A mechanism to constantly apply a bias moment in the opposite direction to the tilt reduces the maximum load moment and makes it possible to avoid the bearing damage while at the same time suppressing the bearing loss considerably.

### BACKGROUND OF THE INVENTION

1. Field of the Invention

This invention relates to a spindle motor adapted to rotate in an environment under the load of a moment to tilt the rotational axis in a predetermined direction and a recording disk driving apparatus having the spindle motor.

2. Description of the Related Art

In many cases, the conventional spindle motor is used under a uniform load. In recent years, however, the spindle motor has come to find a special application in which the rotational axis thereof is decentered intentionally or an unbalanced load is applied while in rotation.

The recording disk driving apparatus rotates a recording disk medium with a spindle motor. With the increased recording density of the recording disk and the improved performance of the magnetic head for reading/writing the information in recent years, the recording disk driving apparatus has been reduced in size and thickness more than ever before. The interior of the recording disk driving apparatus is solidly packed and no extraneous space available therein. Especially, a compact, thin recording disk driving apparatus can contain only one recording disk to save the space and cost, and has a magnetic head arranged only on one side of the recording disk.

The magnetic head is supported by an arm above the recording surface of the recording disk when reading/writing the information. The arm is formed with a suspension, and the magnetic head is pressed on the recording disk under the load in the direction of the rotational axis by the suspension. With the rotation of the recording disk, a dynamic lift is generated in the magnetic head by the surrounding air flow, so that the magnetic head rises against the suspension load. A load due to the reaction of the magnetic head is imposed on the recording disk, and regardless of whether the magnetic head is in contact with the recording disk or not, a load due to the suspension in the direction of the rotational axis is imposed on the recording disk.

In the case where the magnetic head is arranged on each of the two sides of the recording disk, the suspension load would be imposed substantially uniformly on each side of the recording disk, and therefore the opposed loads would be offset with each other, with the result that a large load is not imposed on the recording disk in the direction of the rotational axis. In the case where the magnetic head is arranged only on one side of the recording disk, however, a large suspension load is imposed on the recording disk without being offset, and a rotary member having the recording disk develops a large moment to tilt the rotational axis in one direction.

With the application of the moment to the rotary member, the bearing supporting the rotary member is adversely affected. In the case where the ball bearing is used, for example, the small contact area and the high surface pressure for holding by metal contact is liable to cause a dent or an eccentric wear, resulting in a shorter bearing life. Even in the case where a fluid dynamic bearing is used which, holding a fluid lubrication surface, is considered to have a high strength against the friction and wear as compared with the ball bearing, a repetitive imposition of the load of an excessive moment would cause the wear of the bearing surface, increase the bearing loss (the loss of rotational energy caused by the friction or resistance acting between the axis and the bearing), destabilize the rotation or cause an abnormal vibration, thereby possibly deteriorating the performance of the bearing and the spindle motor.

This problem can be avoided to some degree by improving the bearing rigidity as far as the fluid dynamic bearing is considered a part as a machine element. In order to improve the bearing rigidity, however, it is necessary to increase both the pressure generated in the bearing and the area thereof at the same time. This would lead to a bulky bearing and an increased bearing loss. Due to the limited space, however, it is difficult to mount a large bearing on a compact, thin recording disk driving apparatus. Also, in the case of a battery-driven compact portable device for which the low power consumption is a very crucial specification, the bearing loss cannot be increased even for the purpose of improving the bearing rigidity. This poses a very tough technical problem to deal with, especially for the compact, thin recording disk driving apparatus.

### BRIEF SUMMARY OF THE INVENTION

The present invention has been achieved to solve this problem of the prior art, and the object thereof is to provide a spindle motor and a recording disk driving apparatus having the spindle motor, wherein in the case where the load in the direction of the rotational axis is imposed on the recording disk making up a rotary member by the magnetic head and the moment is applied in the direction to tilt the rotational axis, the particular moment can be offset at least partially without increasing the bearing loss considerably.

In order to achieve this object, according to this invention, there is provided a recording disk driving apparatus, in which a bias means for offsetting at least a part of the moment generated by the pressure applied by the magnetic head against the recording disk is arranged in the structure of the spindle motor, i.e. the housing of the recording disk driving apparatus.

More specifically, the recording disk driving apparatus according to the invention comprises a spindle motor for rotating a recording disk, an information access means having a magnetic head to read and/or write the information from or into the recording disk, a bias means and a housing to accommodate the aforementioned parts therein.

The spindle motor includes a rotary member rotated integrally with the recording disk, a rotor magnet mounted on the rotary member, a stator arranged in opposed relation to the rotor magnet, a stationary member fixed integrally with the stator and a bearing mechanism for rotatably supporting the rotary member on the stationary member. The bearing mechanism can include a ball bearing, a roller bearing, a fluid dynamic bearing, a slide bearing, a gas bearing or any combination thereof.

The information access means includes a head arranged on one side of the recording disk in the direction of the rotational axis thereof and a head arm for supporting the head, moving the head diametrically on the recording disk, moving the head to an arbitrary position on the recording disk and pressing the head against the recording disk.

The bias means imposes the moment to tilt the rotational axis of the rotary member including the recording disk in a predetermined direction.

This bias means roughly fall into two methods.

One preferred application uses the interaction between the rotor magnet and the magnetic pole teeth of the stator. A bias force can be generated by displacing the center of the rotor magnet and the center of the magnetic pole teeth of the stator from each other, changing the area of the magnetic pole teeth of the stator in opposed relation to the rotor magnet in the peripheral direction, changing the gap between the magnetic pole teeth and the rotor magnet in the peripheral direction or changing the number of turns of the coil in the peripheral direction.

Another preferred application uses a magnetic attraction force between the rotor magnet and the stationary member. The portion of the stationary member in opposed relation to the rotor magnet in the direction of the rotational axis is formed of a ferromagnetic material, and the stationary member is formed with a hole, a concave portion or a convex portion. By changing the gap length between the rotor magnet and the stationary member in the peripheral direction, therefore, a bias force can be generated.

More preferably, a bias moment is applied in such a direction that the angle of the line segment connecting the portion of the arm support mechanism mounted on the housing for rotatably supporting the head arm and the rotational axis of the rotary member is between 60 degrees and 120 degrees not inclusive, or depending on the side on which the head is arranged, in the direction 180 degrees symmetric therewith. The direction of moment is defined as a direction 180 degrees symmetric with the direction in which the rotational axis is tilted when the moment is loaded without any other load.

By embodying this invention, the damage due to the unbalanced wear of the bearing and the increased bearing loss can be avoided, and an application of this spindle motor to the recording disk driving apparatus makes it possible to rotate the recording disk in stable fashion.

### BRIEF DESCRIPTION OF THE SEVERAL VIEWS OF THE DRAWINGS

FIG. 1 is a sectional view showing a recording disk driving apparatus according to a first embodiment of the invention.

FIG. 2 is a plan view of a base plate according to the first embodiment of the invention.

FIG. 3 is a sectional view showing a recording disk driving apparatus according to a second embodiment of the invention.

FIG. 4 is a perspective view of a thrust yoke according to the second embodiment of the invention.

FIG. 5 is a perspective view of the thrust yoke according to the second embodiment of the invention.

FIG. 6 is a sectional view showing a recording disk driving apparatus according to a third embodiment of the invention.

FIG. 7 is a plan view schematically showing a magnetic circuit according to the third embodiment of the invention.

FIG. 8 is a plan view schematically showing a magnetic circuit according to a fourth embodiment of the invention.

FIG. 9 is a sectional view showing a recording disk driving apparatus according to an embodiment of the invention.

FIG. 10 is a sectional view showing a bearing mechanism according to a fifth embodiment of the invention.

FIG. 11 is a development schematically showing grooves for generating a radial dynamic pressure according to the fifth embodiment of the invention.

FIG. 12 is a sectional view showing a bearing mechanism according to a sixth embodiment of the invention.

FIG. 13 is a schematic diagram showing grooves for generating a thrust dynamic pressure according to the sixth embodiment of the invention.

FIG. 14 is a sectional view showing a bearing mechanism according to a seventh embodiment of the invention.

### DETAILED DESCRIPTION OF THE INVENTION

An embodiment of the invention is explained below with reference to the drawings. The words or phrases indicating the direction in the following explanation of the invention indicate only the direction as viewed in the drawing unless otherwise specified, and such a direction is not intended to limit the actual direction.

### First Embodiment

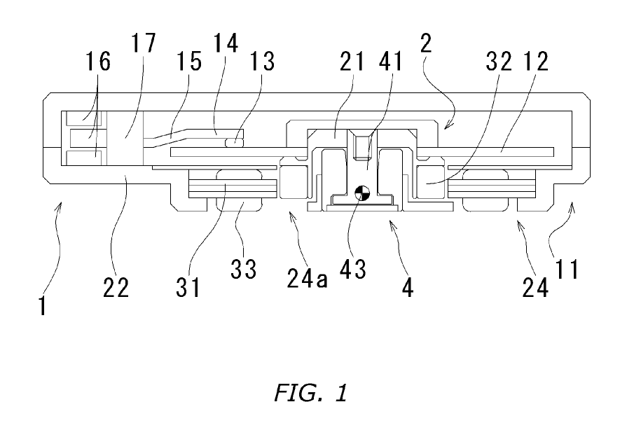

FIG. 1 is a sectional view schematically showing a recording disk driving apparatus according to a first embodiment of the invention.

(1-1) Configuration of Recording Disk

A recording disk driving apparatus 1 comprises a housing 11 containing therein a recording disk 12 for recording the information, a spindle motor 2 for rotating the recording disk 12, a head 13 located on the upper surface of the recording disk 12 in opposed relation to the recording disk 12 through a minuscule gap in the direction of the rotational axis, a head arm 14 for supporting the head 13, and a head suspension 15 for pressing the head 13 formed on the head arm 14 against the recording disk 12 so that the head 13 may not be separately excessively from the recording disk 12. The head arm 14 is mounted on a pivot 17 making up an arm support mechanism and supported rotatably within a predetermined angular range. The head arm 14 is also adapted to swing around the pivot 17 by an actuator 16.

(1-2) Configuration of Spindle Motor

The spindle motor 2 includes a rotor hub making up a rotary member with the recording disk 12 mounted thereon and rotated integrally with the recording disk 12, a rotor magnet 32 mounted on and rotated with the rotor hub 21, and a stator 31 having a plurality of coils 33 located on the outer peripheral surface of the rotor magnet 32, a base plate 22 fixed with the stator 31 and making up the base of the spindle motor 2, and a bearing mechanism 4 for rotatably supporting the rotor hub 21 with respect to the base plate 22.

This embodiment includes a fluid dynamic bearing widely used as a bearing mechanism 4. To produce the effects of the invention, however, a dynamic pressure having other structures or a ball bearing may be equally used. Also, although this embodiment employs the motor of what is called the inner rotor type in which the rotor magnet 32 is arranged diametrically inward of the stator 31, a spindle motor of what is called the outer rotor type can be used with equal effect to embody the invention.

(1-3) Moment Generated By Head

The head 13 is located only on the upper surface of the recording disk 12. Further, the head 13 is pressed against the recording disk 12 in the direction of the rotational axis by the head suspension 15 formed on the head arm 14.

In the case where the rotary side of the bearing mechanism 4 making up a rotary member is rotated integrally with the rotor hub 21 and the recording disk 12, these members can be regarded as substantially rigid bodies (structural members of which the elastic deformation or distortion under stress can be substantially ignored). These rotary members are rotatably supported on the bearing mechanism 4. During the rotation of these rotary members, assume that a force is applied toward a predetermined point from an arbitrary point on the rotary members and the rotary members are shifted not rotationally but parallelly. The predetermined point is called a “rotary member support center point” 43.

In the process, the pressure exerted on the recording disk 12 by the head suspension 15 generates a counterclockwise moment as viewed in FIG. 1 around the rotary member support center point 43. As a result, the rotational axis is tilted in a positive angular direction as viewed in FIG. 1.

(1-4) Base Plate

The base plate 22 makes up a part of the housing 11 of the recording disk driving apparatus 1. The portion of the base plate 22 where the stator 31 is mounted is formed with a plurality of coil relief holes 24 in opposed relation to the coil 33. The stator 31 includes an iron core having a plurality of magnetic pole teeth 35 and the coils 33 wound on the magnetic pole teeth 35. The coil 33 is larger in the direction of the rotational axis than the magnetic pole teeth 35 by the amount equivalent to the winding. The provision of the coil relief holes 24 makes it possible to reduce the size thereof in the direction of the rotational axis when the stator 31 is arranged on the base plate 22.

According to this embodiment, the base plate 22 is formed of SUS400 series stainless steel of a ferromagnetic material. The SUS400 series stainless steel of both ferrite and martensite groups have a ferromagnetism and a high workability. Therefore, the base plate having a high machining accuracy can be mass produced at low cost by pressing, etc. In accordance with the mechanical strength and other machining requirements of the recording disk driving apparatus 1, the silicon steel plate, the zinc-coated steel plate or the like ferromagnetic material can be selectively used.

(1-5) Opposite Moment

The lower end surface of the rotor magnet 32 is in opposed relation to the upper end surface of the base plate 22. The rotor magnet 32 is a permanent magnet and generates a magnetic attraction force with the base plate 22 of a ferromagnetic material. The rotor magnet 32, the rotor hub 21 and the recording disk 12 are attracted toward the base plate 22 by this magnetic attraction force. By changing this magnetic attraction force along the peripheral direction, the moment generated in the head 13 described in (1-3) above is partially offset.

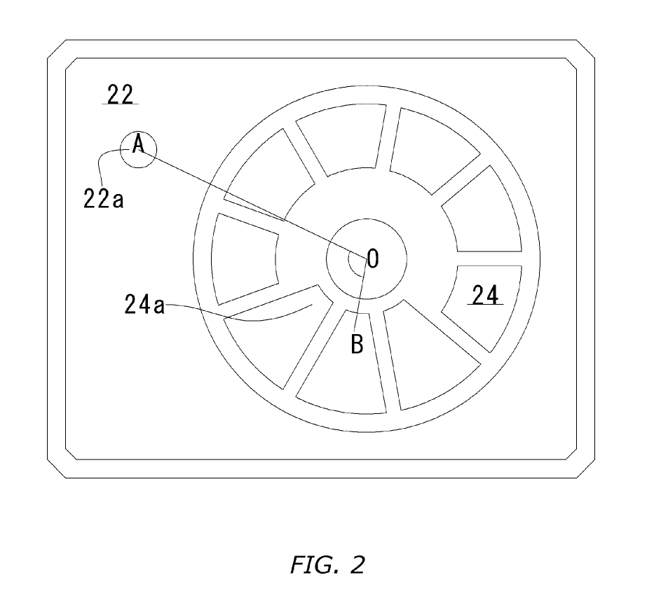

FIG. 2 is a plan view showing the base plate 22 according to this embodiment. As many coil relief holes 24 (nine holes according to this embodiment) as the magnetic pole teeth 35 wound with the coils 33 are formed. The four coil relief holes 24a located on the left side are extended to the rotational axis from under the coils 33.

The base plate 22 is formed with a pivot mounting hole 22a for mounting a pivot 17. The line segment connecting the center A of the pivot mounting hole 22a and the rotational center O of the spindle motor is defined as AO. Also, the line segment connecting the center B of the coil relief holes 24a extended as a bias means and the rotational center O of the spindle motor is defined as BO. According to this embodiment, the angle ∠AOB formed between AO and BO is about 105 degrees. The moment generated by the bias means under this condition works in such a direction as to offset at least a part of the moment generated by the pressure imparted on the recording disk 12 by the head 13.

By doing so, the magnetic attraction force acting between the rotor magnet 32 and the base plate 22 along the peripheral direction of rotation is weak on the left side in FIG. 1 where the coil relief holes 24 are extended toward the rotational axis and strong on the right side where the rotor magnet 32 and the base plate 22 are not in opposed relation to each other. The difference of magnetic attraction force between the left and right sides generates a moment for rotating the rotational axis clockwise around the rotary member support center point 43.

(1-6) Operation

According to this embodiment, the diameter of the recording disk 12 is 1.0 inch (25.4 mm), and the pressure imparted by the head suspension in the axial direction is 2.5 gf. The minimum information recordable diameter of the recording disk 12 is about 12 mm. The rotary member support center point 43 is located on the rotational axis. The height of the rotary member support center point 43 along the rotational axis, which is affected by the conditions including the bearing specifications, is designed to substantially coincide with the center of gravity of the rotary member according to this invention. The magnitude of the moment generated around the rotary member support center point 43 by the head suspension 15, therefore, is about 15 to 32 g·mm.

As described above in (1-5), the magnitude of the moment imposed in the direction offsetting the moment generated by the head suspension 15 can be regarded as the intermediate value of the moment generated by the head suspension 15. Specifically, it is about 24 g·mm. In this way, the moment of at most about 8.4 g·mm is loaded on the bearing. This value is at least about one half or at most about one fourth as large as the moment generated by the head suspension 15.

Suppose the head 13 is arranged on each of the upper and lower surfaces of the recording disk 12. The individual variation of the pressure imposed by the head suspension is about 10%. In the case where the recording disk 12 of the same size as in this embodiment is used, the variation of about 10% would lead to a maximum of about 6.6 g·mm in the magnitude of the moment loaded around the rotary member support center point 43. Specifically, in the method according to this embodiment, the difference is only about 20 to 30% in terms of the magnitude of moment. The bearing mechanism widely in use, therefore, can support this magnitude of moment sufficiently.

According to this embodiment, a sintered magnet of Nd—Fe—B group high in surface magnetic flux density is used as the rotor magnet 32. The magnetic attraction force generated between the rotor magnet 32 and the base plate 22, therefore, is sufficiently large, so that a sufficient moment to oppose the moment generated by the head suspension 15 is generated, and the magnitude of the latter moment can be adjusted appropriately. According to this embodiment, the diameter of the outer peripheral surface of the rotor magnet 32 is 9.4 mm, and the interval between the base plate 22 and the rotor magnet 32 along the direction of the rotational axis is at least 0.16 mm. The magnetic attraction force between the rotor magnet 32 and the base plate 22 can be changed as required by changing the distance along the rotational axis between the rotor magnet 32 and the base plate 22, the magnetization waveform of the rotor magnet 32, the shape and position of the extension of the winding relief holes formed at the portion opposed to the lower end of the rotor magnet 32. By doing so, the optimum design conforming to the characteristics of the rotary member, the spindle motor 2 and the recording disk driving apparatus 1 can be achieved. Also, the magnetic attraction force can be considerably changed by the material and size of the rotor magnet 32, the material and thickness of the base plate 22 or the design of the magnetic circuit.

(1-7) Effects

According to this embodiment, the moment as large as 15 to 32 g·mm is generated by the head 13, the head arm 14 supporting the head 13 and the head suspension 16. By appropriately designing the shape of the base plate 22 facing the rotor magnet 32 in such a manner that the offset moment is generated by the magnetic attraction force working with the rotor magnet 32, however, the moment generated can be reduced to about one fourth in maximum or at least one half, i.e. about 8 to 9 g·mm. In the case where the moment generated is contained in this range, the effect on the bearing can be minimized and the need of sizable design change of the bearing mechanism 4 is eliminated. As a result, the bearing rigidity is not required to be increased considerably and the increase in bearing loss can be avoided.

### Second Embodiment

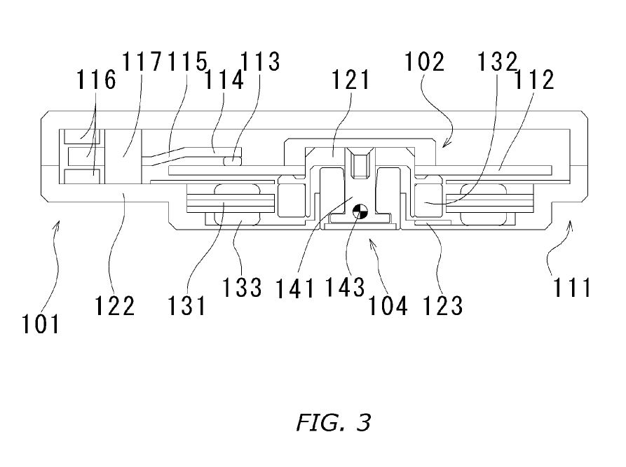

FIG. 3 is a sectional view schematically showing a recording disk driving apparatus according to a second embodiment of the invention.

(2-1) Configuration of Recording Disk

The recording disk driving apparatus 101 according to this embodiment has a similar configuration to the counterpart according to the first embodiment described in (1-1). Specifically, a housing 111 accommodates therein a recording disk 112 for recording the information, a spindle motor 102 for rotating the recording disk 112, a head 113 arranged on the upper surface of the recording disk 112 in opposed relation to the recording disk 112 through a minuscule gap in the direction of the rotational axis, a head arm 114 for supporting the head 113 and a head suspension 115 formed on the head arm 114 to press the head 113 toward the recording disk 112 not to be separated from the recording disk 112 excessively.

According to this embodiment, the head arm 114 operates in the same way as in the first embodiment to move onto an arbitrary point on the recording disk.

(2-2) Configuration of Spindle Motor

The spindle motor 102 according to this embodiment includes a rotor hub 121 with the recording disk 112 mounted thereon and constituting a rotary member adapted to rotate integrally with the recording disk 112, a rotor magnet 132 mounted on and rotated with the rotor hub 121, a stator 131 located on the outer peripheral surface of the rotor magnet 132 and having a plurality of coils 133, a base plate 122 with the stator 131 fixed thereon and constituting the base of the spindle motor 102, a bearing mechanism 104 for supporting the rotor hub 121 rotatably on the base plate 122, and a thrust yoke 123 arranged on the base plate 122 in opposed relation to the lower end surface of the rotor magnet 132.

According to this embodiment, a fluid dynamic bearing finding a wide application is used in the bearing mechanism 104. In order to produce the effects of this invention, however, the fluid dynamic bearing having other structures or the ball bearing can alternatively be used. According to this embodiment, the rotor magnet 132 employs the motor of what is called the inner rotor type with the rotor magnet 132 arranged diametrically inward of the stator 131. Nevertheless, the spindle motor of outer rotor type can alternatively be used to embody the invention with equal effect.

(2-3) Moment Generated By Head

The head 113 is located only on the upper surface of the recording disk 112 like in the first embodiment. Further, the head 113 is pressed against the recording disk 112 in the direction of the rotational axis by the head suspension 115 formed on the head arm 114.

The rotary member support center point 43 defined in the first embodiment is similarly defined as a rotary member support center point 143 according to this embodiment.

In the process, the pressure imposed on the recording disk 112 by the head suspension 115 generates a counterclockwise moment as viewed in FIG. 3 around the rotary member support center point 143. As a result, the rotational axis can be tilted in positive angular direction as viewed in FIG. 3.

(2-4) Thrust Yoke

The thrust yoke 123 is arranged on the base plate 122 in opposed relation to the lower end surface of the rotor magnet 132. The thrust yoke 123 is a C-shaped or a horse-shoe member cut away partly from an annular flat plate.

According to this embodiment, the thrust yoke 123 is formed of a silicon steel plate having a ferromagnetic characteristic. The silicon steel plate has a high saturated magnetic flux density and exhibits a very high ferromagnetism. The thrust yoke is formed by punching a flat plate, and therefore requires no high workability. As far as a high ferromagnetism is exhibited, any ferromagnetic material such as SUS400 series stainless steel or zinc-coated steel plate can be selectively used.

(2-5) Opposite Moment

The lower end surface of the rotor magnet 132 faces the upper end surface of the thrust yoke 123. The rotor magnet 132 is a permanent magnet, and generates a magnetic attraction force with the ferromagnetic thrust yoke 123. By this magnetic attraction force, the rotor magnet 132, the rotor hub 121 and the recording disk 112 are attracted to the thrust yoke 123. By changing this magnetic attraction force along the peripheral direction, part of the moment generated by the head 113 described in (1-3) can be offset.

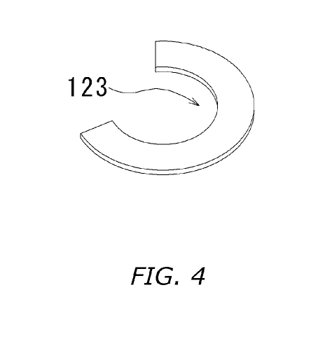

FIG. 4 is a plan view showing the thrust yoke 123 according to this embodiment. The left side of FIG. 4 is partly cut away.

In this case, the magnetic attraction force between the rotor magnet 132 and the thrust yoke 123 along the peripheral direction of rotation is weak on the left side of FIG. 4 cut away, and strong at the portion on the right side where the rotor magnet 132 and the base plate are not in opposed relation to each other. In accordance with the difference in magnetic attraction force between left and right sides, therefore, a moment is generated to rotate the rotational axis clockwise around the rotary member support center point 143.

(2-6) Operation

According to this embodiment, the operation of the moment around the rotary member support center point is similar to that in the first embodiment.

According to this embodiment, like in the first embodiment, a sintered magnet of Nd—Fe—B group high in surface magnetic flux density is used as the rotor magnet 132. The thrust yoke 132 of a silicon steel plate, on the other hand, though thinner than the base plate according to the first embodiment, has a high saturated magnetic flux density. As a result, the magnetic attraction force between the rotor magnet 132 and the thrust yoke 123 is sufficiently large. Thus, a moment opposed to the moment generated by the head suspension 15 can be sufficiently generated and the magnitude of the moment can be appropriately adjusted. The magnetic attraction force between the rotor magnet 132 and the thrust plate 123 can be changed as desired by changing the distance between the rotor magnet 132 and the thrust plate 123 in the direction of the rotational axis, the magnetization waveform of the rotor magnet 132 or the shape or the range of notching the thrust plate. By doing so, an optimum design conforming to the characteristics of the rotary member and the spindle motor 102 and the characteristics of the recording disk driving apparatus 101 can be attained.

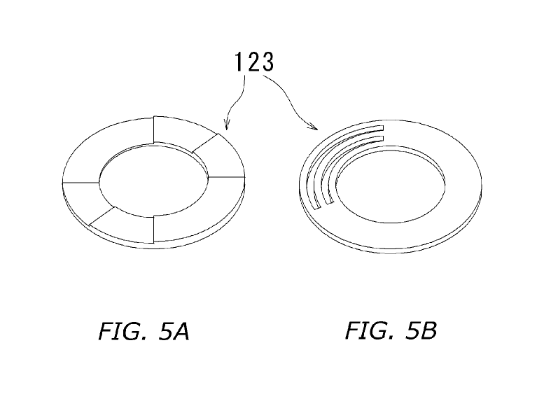

Also, without cutting away the thrust yoke 123, as shown in FIGS. 5A and 5B, the thickness of the left side may be reduced while increasing the thickness of the right side, or a hole can be formed without cutting away the left side. Also in this way, the magnetic attraction force working between the rotor magnet 132 and the thrust yoke 123 can be changed along the peripheral direction.

(2-7) Effects

According to this embodiment, like in the first embodiment, the head 113, the head arm 114 supporting the head 113 and the head suspension 116 generate a moment as large as 15 to 32 g·mm. This moment can be reduced considerably, however, by appropriately designing the shape of the thrust yoke 123 facing the lower end surface of the rotor magnet 132 and thus generating a moment offsetting the moment exerted by the head by the magnetic attraction force generated with the rotor magnet 132. By containing the moment generation within this range, the effect on the bearing can be minimized, and therefore, any sizable design change of the bearing mechanism 104 is not required. Thus, the requirement to increase the bearing rigidity is eliminated thereby to avoid the increase in bearing loss.

### Third Embodiment

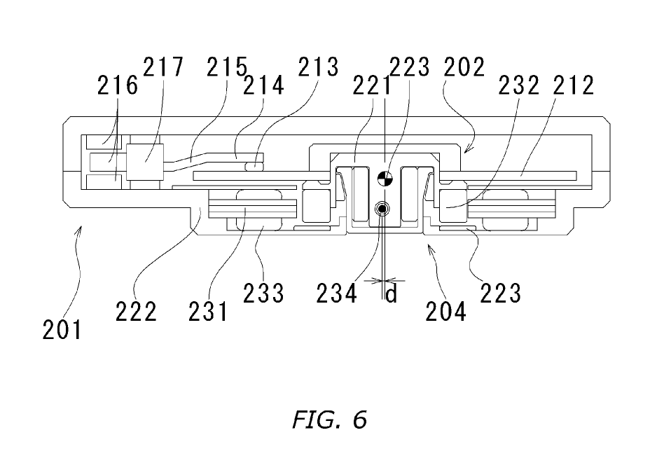

FIG. 6 is a sectional view schematically showing a recording disk driving apparatus according to a third embodiment of the invention.

(3-1) Configuration of Recording Disk

A recording disk driving apparatus 201 according to this embodiment has a similar configuration to the counterpart according to the first embodiment described in (1-1). Specifically, the housing 211 accommodates therein a recording disk 212 for recording the information, a spindle motor 202 for rotating the recording disk 212, a head 213 arranged on the upper surface of the recording disk 212 in opposed relation to the recording disk 212 through a minuscule gap in the direction along the rotational axis, a head arm 214 for supporting the head 213 and a head suspension 215 formed on the head arm 214 and for pressing the head 213 toward the recording disk 212 so that the head 213 is not separated excessively from the recording disk 212.

(3-2) Configuration of Spindle Motor

According to this embodiment, the spindle motor 202 includes a rotor hub 221 with the recording disk 212 mounted thereon and making up a rotary member rotated integrally with the recording disk 212, a rotor magnet 232 mounted on and rotated with the rotor hub 221, a stator 231 located on the outer peripheral surface of the rotor magnet 232 and having a plurality of coils 233, a base plate 222 fixed with the stator 231 and making up the base of the spindle motor 202, and a bearing mechanism 204 for rotatably supporting the rotor hub 221 with respect to the base plate 222. The rotor magnet 232 and the stator 231 constitute a driving unit for the spindle motor 202 and form a magnetic circuit 203.

According to this embodiment, the fluid dynamic bearing finding a wide application is used in the bearing mechanism 204. In order to produce the effects of this invention, however, a dynamic bearing having other structures or a ball bearing can be equally used. Also, instead of the motor of what is called the inner rotor type with the rotor magnet 232 arranged diametrically inward of the stator 231 as employed in this embodiment, the spindle motor of outer rotor type can of course be employed to embody the invention with equal effect.

(3-3) Moment Generated By Head

The head 213 is located only on the upper surface of the recording disk 212 like in the first embodiment. Further, the head 213 is pressed toward the recording disk 212 in the direction along the rotational axis by the head suspension 215 formed on the head arm 214.

The rotary member support center point 43 defined in the first embodiment is similarly defined as a rotary member support center point 243 in this embodiment.

In this case, the pressure imposed on the recording disk 212 by the head suspension 215 generates a counterclockwise moment as viewed in FIG. 6 around the rotary member support center point 243. As a result, the rotational axis is tilted in positive angular direction as viewed in FIG. 6.

(3-4) Magnetic Circuit

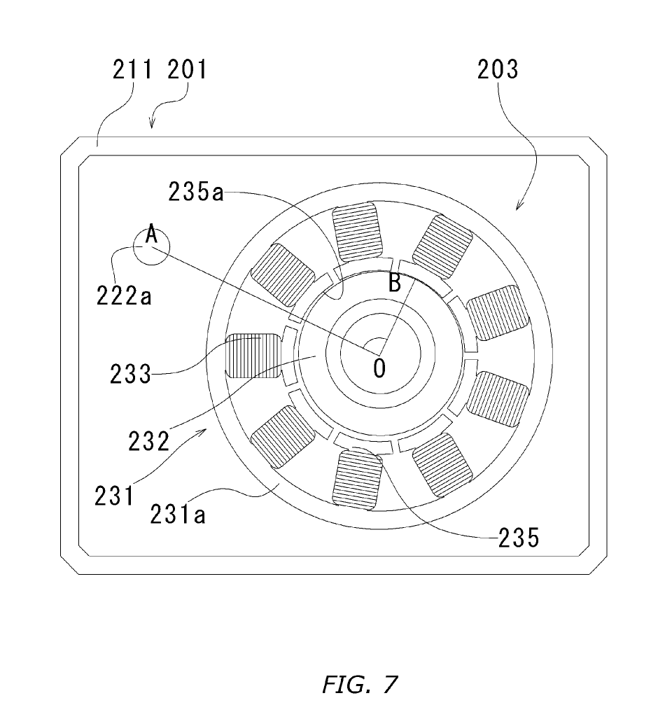

FIG. 7 is a plan view schematically showing the relative positions of the rotor magnet 232 and the stator 231 according to this embodiment. The stator 231 includes an annular core back 231a arranged on the outer peripheral portion, magnetic pole teeth 235 extending diametrically inward from the core back 231a, and coils 233 individually wound on the magnetic pole teeth 235. The inner peripheral end portion of the magnetic pole teeth 235 has a magnetic pole tooth end surface 235a forming a part of the peripheral surface widened in the peripheral direction. The magnetic pole tooth end surface 235a is in opposed relation to the outer peripheral surface of the rotor magnet 232 through a gap d. This gap d is progressively enlarged leftward along the periphery of the rotor magnet 232. Specifically, the center axis of the rotor magnet 232 making up the rotational axis is shifted rightward from the center 234 of the stator 231 constituting the center of the magnetic circuit 203.

According to this embodiment, a pivot mounting hole 222a for mounting the pivot 217 is formed on the base plate 222. The line segment connecting the center point A of the pivot mounting hole 222a and the rotational center O of the spindle motor is defined as AO. Also, the line segment connecting the point B having the smallest gap between the rotor magnet 232 providing the bias means and the inner peripheral surface 235a of the magnetic pole teeth of the stator 231 on the one hand and the rotational center O of the spindle motor on the other hand is defined as BO. According to this embodiment, the angle ∠AOB formed between AO and BO is about 90 degrees. Under this condition, the moment generated by the bias means works in such a direction as to offset at least part of the pressure moment generated by the pressure with which the head 213 presses the recording disk 212.

(3-5) Opposite Moment

According to this embodiment, the rotary member support center point 243 is substantially coincident with or slightly displaced above the center of gravity of the rotary member, or as viewed in the direction along the rotational axis, displaced upward of the stator center. As described in (3-4), in view of the fact that the rotational axis is shifted rightward of the stator center 234, a radial bias force to move the rotational axis toward the center of the magnetic circuit 203 is exerted on the rotor magnet 232. This radial bias force works leftward under the rotary member support center point 243 and generates a moment to tilt the rotational axis clockwise around the rotary member support center point 243.

(3-6) Operation

The moment generated in the head 215 described in (3-3) and the moment generated in the magnetic circuit 203 described in (3-5) are in opposed relation to each other and offset part of the moment generated by the head 215.

(3-7) Effects

According to this embodiment, like in the first embodiment, a moment as large as 15 to 32 g·mm is generated by the head 213, the head arm 214 supporting the head 213 and the head suspension 216. In the case where the rotational axis is arranged at a position displaced from the stator center 234, however, a moment offsetting the moment imposed by the head is generated by taking advantage of the radial bias force urging the magnetic circuit 203 to return the rotational axis to the stator center 234, thereby making it possible to considerably reduce the generation of the moment. As a result, the effect that the moment has on the bearing is reduced on the one hand, and the bearing mechanism 204 is not required to be redesigned on a large scale at the same time. As a result, the bearing rigidity is not required to be increased and the increase in bearing loss is avoided.

### Fourth Embodiment

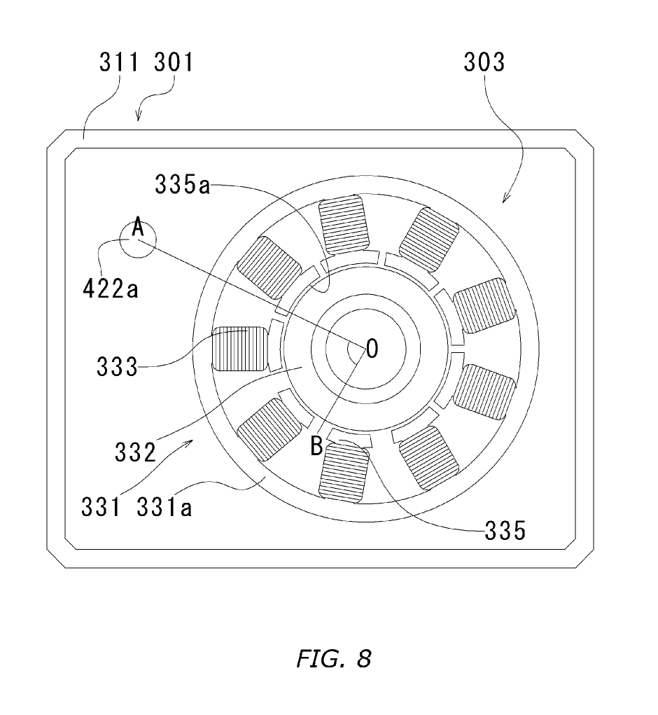

FIG. 8 is a plan view schematically showing a recording disk driving apparatus according to a fourth embodiment of the invention.

(4-1) Configuration of Recording Disk

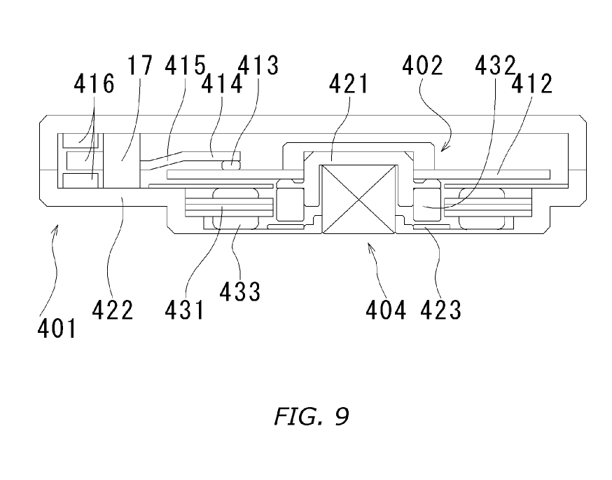

A recording disk driving apparatus 401 according to this embodiment has a configuration shown in FIG. 9, which is similar to the first embodiment described in (1-1). Specifically, a housing 411 accommodates therein a recording disk 412 for recording the information, a spindle motor 402 for rotating the recording disk 412, a head 413 located on the upper surface of the recording disk 412 in opposed relation to the recording disk 412 through a minuscule gap in the direction of the rotational axis therebetween, a head arm 414 for supporting the head 413 and a head suspension 415 formed on the head arm 414 and for pressing the head 413 toward the recording disk 412 so as not to be separated excessively from the recording disk 412.

(4-2) Configuration of Spindle Motor

The spindle motor 402 according to this embodiment has a similar configuration to that shown in FIG. 9, except that the magnetic circuit 303 thereof has a different feature. The rotor magnet 432, the stator 431, the coil 433 making up the stator 431 and the magnetic pole teeth 435 shown in FIG. 9 are not used in this embodiment. Instead, the magnetic circuit 303 according to the invention has a configuration described below. Specifically, the magnetic circuit 303 according to this embodiment includes a rotor hub 421 with the recording disk 412 mounted thereon and constituting a rotary member integrally rotated with the recording disk 412, a rotor magnet 332 mounted on and rotated with the rotor hub 421, a stator 331 arranged on the outer peripheral surface of the rotor magnet 332 and having a plurality of coils 333, a base plate 422 fixed with the stator 331 and providing the base of the spindle motor 402, and a bearing mechanism 404 for rotatably supporting the rotor hub 421 with respect to the base plate 422. The rotor magnet 332 and the stator 331 constitute a driving unit for the spindle motor 402 and form the magnetic circuit 303.

According to this embodiment, the fluid dynamic bearing finding a wide application is used in the bearing mechanism 404. To achieve the effects of the invention, however, the dynamic bearings having other structures or the ball bearing can be used with equal effect. Also, unlike in this embodiment employing the motor of what is called inner rotor type with the rotor magnet 332 arranged diametrically inward of the stator 331, the spindle motor of outer rotor type can be employed to embody the invention with equal effect.

(4-3) Moment Generated By Head

The head 413 is located only on the upper surface of the recording disk 412 as in the first embodiment. Further, the head 413 is pressed toward the recording disk 412 in the direction along the rotational axis by the suspension head 415 formed on the head arm 414.

The rotary member support center point 43 defined in the first embodiment is similarly defined also as a rotary member support center point 443 in this embodiment.

The spindle motor and the recording disk apparatus according to this embodiment have the same longitudinal sectional view as those of the third embodiment, as shown in FIG. 9. The pressure imparted on the recording disk 412 by the head suspension 415 generates a counterclockwise moment as viewed in FIG. 9 around the rotary member support center point 443. As a result, the rotational axis is tilted in a positive angular direction as viewed in FIG. 9.

(4-4) Magnetic Circuit

The stator 331 is configured of an annular core back 331 a arranged on the outer periphery thereof, magnetic pole teeth 335 extending diametrically inward of the core back 331a, and coils 333 individually wound on each of the magnetic pole teeth 35. The inner peripheral end portion of the magnetic pole teeth 335 has a magnetic pole tooth end surface 335a forming a part of the peripheral surface widened along the peripheral direction. The magnetic pole tooth end surface 335a faces the outer peripheral surface of the rotor magnet 332 through a gap d. The area of the surface of the magnetic tooth end surface 335a in opposed relation to the outer peripheral surface of the rotor magnet 332 is wide on the right side and narrow on the left side as viewed in FIG. 8.

(4-5) Opposite Moment

According to this embodiment, the rotary member support center point 443 is substantially coincident with or located slightly above the center of gravity of the rotary member. As viewed in the direction along the rotational axis, however, the rotary member support center point 443 is located above the center of the stator. As described in (4-4), the area of the magnetic pole tooth end surface 335a facing the outer peripheral surface of the rotor magnet 332 is wide on the right side and narrow on the left side as viewed in FIG. 8. Once a current is supplied to the coils 333, the magnetic fluxes are diametrically penetrated and passed diametrically inward of the magnetic pole tooth end surface 335a and magnetically reacting with the rotor magnet 332, generates a driving force. The end surface 335a of the magnetic pole teeth 335 is wider than the sectional area of the coils 333 of the magnetic pole teeth 335 so as to be opposed to the magnetic pole teeth with a wider area than the outer peripheral surface of the rotor magnet 332 and to draw an ideal sinusoidal wave of the magnetic field. As a result, a slight amount of magnetic fluxes leaks into the adjacent magnetic pole teeth 335 and the magnetic fluxes are shorted. By reducing the area of the magnetic tooth end surface 335a located on the left side as viewed in FIG. 8, therefore, the magnetic fluxes are changed sharply thereby to maximize the interaction with the rotor magnet 332. In this way, a leftward radial bias force is exerted on the rotor magnet 332 and the rotor hub 421 and the recording disk 412 rotated integrally with each other. This radial bias force works leftward under the rotary member support center point 443 of the rotational axis, and generates a moment to tilt the rotational axis clockwise around the rotary member support center point 443.

The base plate 422 is formed with a pivot mounting hole 422a to mount the pivot 417. The line segment connecting the center point A of the pivot mounting hole 422a and the rotational center O of the spindle motor is defined as AO. Also, the line segment connecting the center point B of the magnetic pole teeth 335a cut away from a part of the inner peripheral surface providing a bias means and the rotational center O of the spindle motor is defined as BO. According to this embodiment, the angle ∠AOB formed between the line segments AO and BO is about 85 degrees. In the process, the moment generated by the bias means works in such a direction as to offset at least part of the pressure moment generated by the pressure generated by the head 413 to the recording disk 412.

(4-6) Operation

The moment generated by the head 415 described in (4-3) and the moment generated by the magnetic circuit 303 described in (4-5) are opposed to each other thereby to offset part of the moment generated by the head 415.

(4-7) Effects

According to this embodiment, like in the first embodiment, a moment as large as 15 to 32 g·mm is generated by the head 413, the head arm 414 supporting the head 413 and the head suspension 416. Nevertheless, in view of the fact that the area of the magnetic pole tooth end surface 335a is wide on the right side and narrow on the left side as viewed in FIG. 8 so that the radial bias force of the rotor magnet is applied leftward by the magnetic circuit 303, a moment can be generated in such a direction as to offset the moment imposed by the head, thereby making it possible to reduce the generation of moment considerably. At the same time, no sizable design change of the bearing mechanism 404 is required. As a result, the bearing rigidity is not required to be increased and the increase in the bearing loss is avoided.

### Fifth Embodiment

FIG. 9 is a sectional view schematically showing a recording disk driving apparatus according to a fifth embodiment of the invention.

(5-1) Configuration of Recording Disk

The recording disk driving apparatus 401 according to this embodiment has a similar configuration to the counterpart according to the first embodiment described in (1-1). Specifically, a housing 411 accommodates therein a recording disk 412 for recording the information, a spindle motor 402 for rotating the recording disk 412, a head 413 located on the upper surface of the recording disk 412 in opposed relation to the recording disk 412 through a minuscule gap in the direction along the rotational axis, a head arm 414 for supporting the head 413, and a head suspension 415 formed on the head arm 414 and for pressing the head 413 toward the recording disk 412 so that the head 413 is not separated excessively from the recording disk 412.

(5-2) Configuration of Spindle Motor

The spindle motor 402 according to this embodiment includes a rotor hub 421 making up a rotary member rotated integrally with a recording disk 412 mounted thereon, a rotor magnet 432 mounted on and rotated with the rotor hub 421, a stator 431 located on the outer peripheral surface of the rotor magnet 432 and having a plurality of coils 433, a base plate 422 fixed with the stator 431 and providing the base of the spindle motor 402, and a bearing mechanism 404 for rotatably supporting the rotor hub 421 with respect to the base plate 422. The rotor magnet 432 and the stator 431 constitute a driving unit for the spindle motor 402 and form a magnetic circuit 403.

According to this embodiment, the motor of what is called the inner rotor type is employed in which the rotor magnet 432 is arranged diametrically inward of the stator 431. Nevertheless, the motor of outer rotor type can be employed to embody the invention with equal effect.

(5-3) Moment Generated By Head

Like in the first embodiment, the head 413 is located only on the upper surface of the recording disk 412. Further, the head 413 is pressed toward the recording disk 412 in the direction along the rotational axis by the head suspension 415 formed on the head arm 414.

The rotary member support center point 43 defined in the first embodiment is similarly defined as a rotary member support center point 443 in this embodiment.

The longitudinal sectional view showing this embodiment is similar to that of the third embodiment, as shown in FIG. 6. The pressure applied to the recording disk 412 by the head suspension 415 generates a counterclockwise moment as viewed in FIG. 6 around the rotary member support center point 443. As a result, the rotational axis is tilted in a positive angular direction as viewed in FIG. 6.

(5-4) Bearing Structure

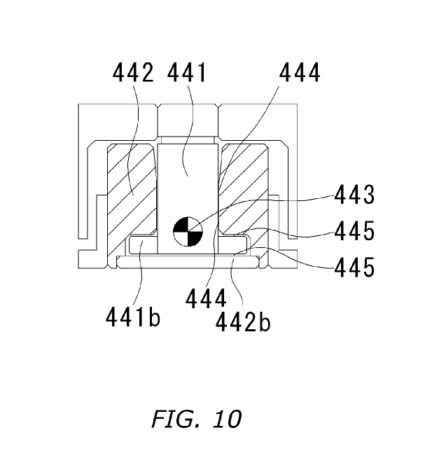

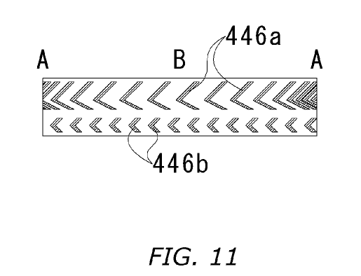

FIG. 10 is a longitudinal sectional view showing the bearing structure 404 according to this embodiment, and FIG. 11 is a development schematically showing grooves for generating a radial dynamic pressure. The bearing structure 404 according to this embodiment includes a sleeve 442 fixed on a base plate 422, and a shaft 441 fixed integrally on a rotor hub 421. The sleeve 442 has a cylindrical inner peripheral surface which makes up a bearing hole. The shaft 441 has a cylindrical outer peripheral surface and is fitted in the bearing hole through a minuscule diametrical gap. A dynamic pressure generating fluid is interposed in the diametrical gap between the outer peripheral surface of the shaft 441 and the inner peripheral surface of the sleeve 442 thereby to constitute a radial dynamic bearing 444. Further, the inner peripheral surface of the sleeve 442 is formed with a pair of radial dynamic pressure generating grooves spaced with each other in the direction along the rotational axis for promoting the generation of the radial dynamic pressure at two points in the direction along the rotational axis. Of these two radial dynamic pressure generating grooves 446, the upper one is designated as a radial dynamic pressure generating groove 446a, and the lower one as a radial dynamic pressure generating groove 446b. Similarly, the radial dynamic bearing mainly supporting the increased dynamic pressure in the upper radial dynamic pressure generating groove 446a is designated as a radial dynamic bearing 444a, and the one mainly supporting the increased dynamic pressure in the lower radial dynamic pressure generating groove 446b designated as a radial dynamic bearing 444b.

According to this embodiment, as the radial dynamic bearing 444, the herringbone grooved journal bearing named from its resemblance to the bone of a herring is employed. Nevertheless, as far as the dynamic pressure is increased toward the center of the grooves in the direction along the rotational axis at the time of rotation, the grooves may be formed into any of various shapes such as the roughly curved shape like a sine curve, the partly grooved shape in which a flat and smooth portion is provided in the intermediate portion in the axial direction, or the circumferentially grooved shape like a fish bone in which a plurality of grooves are communicated in the intermediate portion in the axial direction. Also, the shape with the asymmetrical pattern in the upper and lower portions in the axial direction may be employed thereby to generate the dynamic pressure unbalanced in the direction along the rotational axis.

An annular thrust plate 441b is fixed integrally at the lower end of the shaft 441. The upper end surface of the thrust plate 441b is in opposed relation to the lower surface of the sleeve 442 through a minuscule gap in the direction along the rotational axis. The lower end of the sleeve 442, on the other hand, is sealed by a counter plate 442b. The lower end surface of the thrust plate 441b is in opposed relation to the counter plate 442b through a minuscule gap in the direction along the rotational axis. A dynamic pressure generating fluid is interposed in the minuscule gaps formed above and under the thrust plate 441b in the direction along the rotational axis thereby to make up a thrust dynamic bearing 445 at each of two points above and under the thrust plate 441b. Further, the surface of the sleeve 442 opposed to the upper end surface of the thrust plate 441b is formed with a thrust dynamic pressure generating groove 447 to promote the generation of the thrust dynamic pressure. The upper end surface of the counter plate 442b is also formed with the thrust dynamic pressure generating groove 447 to promote the generation of the thrust dynamic pressure. These two thrust dynamic bearings 445 generate the thrust dynamic pressure in vertically opposite directions, respectively, and thereby support the load in the direction along the rotational axis.

According to this embodiment, a lubricant is used as a dynamic pressure generating fluid. Depending on the conditions for rotation or the bearing structure, however, the air, a gas, a gel or grease may alternatively be used as the dynamic pressure generating fluid.

(5-5) Opposite Moment

According to this embodiment, the rotary member support center point 443 constitutes the center of the dynamic pressure generated by the radial dynamic bearing 444 and the thrust dynamic bearing 445, and located slightly above the lower radial dynamic bearing 444b.

The peripheral intervals of the herring bone grooves of the upper radial dynamic pressure generating groove 446a are changed in the peripheral direction. FIG. 11 is a diagram showing the development of the radial dynamic pressure generating grooves 446a, 446b involved. In FIG. 11, point A corresponds to the left side in FIG. 10, and point B the right side in FIG. 10. At the position corresponding to point A, the groove intervals are so small that a high dynamic pressure is generated. At the position corresponding to point B, on the other hand, the groove intervals are larger, so that the dynamic pressure generated at the same diametrical position is lower than for point A. In the upper radial dynamic bearing 444a, therefore, an unbalanced dynamic pressure is generated. The upper radial dynamic bearing 444a is located above the rotary member support center point 443, and therefore the unbalance caused by the dynamic pressure generates a moment. This moment is generated by the unbalanced force of the dynamic pressure generated from point A toward point B in the clockwise direction of the rotational axis as viewed in FIG. 10.

(5-6) Operation

The moment generated by the head 415 described in (4-3) and the moment generated by the unbalanced state of the upper radial dynamic bearing 444a described in (5-5) are opposed to each other thereby to offset part of the moment generated by the head 415.

(5-7) Effects

According to this embodiment, like in the first embodiment, a moment as large as 15 to 32 g·mm is generated by the head 413, the head arm 414 supporting the head 413 and the head suspension 416. The unbalance is generated, however, by the provision of both large and short intervals along the peripheral direction of the radial dynamic pressure generating grooves 446 for promoting the generation of the dynamic pressure of the upper radial dynamic bearing 444a. This unbalance of the radial dynamic bearing 444 generates a moment in such a direction as to offset the moment imposed by the head. In this way, the load of the moment generated by the head 413 can be reduced considerably. This structure imposes a predetermined radial dynamic pressure and therefore stabilizes the rotation. In addition, the reduction in the moment load to be supported by the bearing prevents the rigidity required by the bearing from being greatly increased thereby to prevent the bearing loss from being considerably increased.

### Sixth Embodiment

(6-1) Configuration of Recording Disk and Spindle Motor

The recording disk driving apparatus 501 and the spindle motor 502 according to this embodiment are substantially similar to the recording disk driving apparatus 401 and the spindle motor 402, respectively, according to the fifth embodiment, although the bearing mechanism 504 is different from the bearing mechanism 404 according to the fifth embodiment. According to this embodiment, the motor of what is called inner rotor type with the rotor magnet 432 arranged diametrically inward of the stator 431 is employed. Nevertheless, the spindle motor of outer rotor type can alternatively be employed to embody the invention with equal effect.

(6-2) Moment Generated By Head

The longitudinal sectional view of this embodiment is shown in FIG. 9 and similar to that of the fifth embodiment. The pressure exerted by the head suspension 415 on the recording disk 413 generates a counterclockwise moment as viewed in FIG. 9 around the rotary member support center point 543. As a result, the rotational axis is tilted in an angular positive direction as viewed in FIG. 9.

(6-3) Bearing Structure

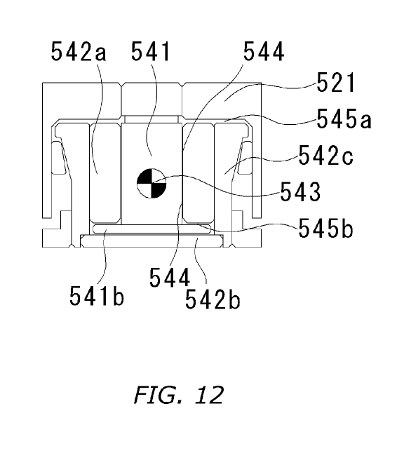

FIG. 12 is a longitudinal sectional view of the bearing mechanism 504 according to this embodiment. The bearing mechanism 504 according to this embodiment includes a sleeve housing 542c fixed on a base plate 422, a sleeve 542a, and a shaft 541 fixed integrally with a rotor hub 521. The sleeve 542a has a cylindrical inner peripheral surface making up a bearing hole. The shaft 541 has a cylindrical outer peripheral surface and is fitted in the bearing hole through a minuscule diametrical gap. A dynamic pressure generating fluid is interposed in the diametrical gap formed between the outer peripheral surface of the shaft 541 and the inner peripheral surface of the sleeve 542a thereby to make up a radial dynamic bearing 544. Further, the inner peripheral surface of the sleeve 542a is formed with a pair of radial dynamic pressure generating grooves 546 spaced with each in the direction along the rotational axis thereby to promote the generation of the radial dynamic pressure at two points in the direction along the rotational axis.

The upper end surface of the sleeve housing 542c is opposed to the lower flat surface of the rotor hub 521 through a minuscule gap in the direction along the rotational axis. The lower end of the shaft 541 is screwed with the thrust plate 541b. The upper end surface of the thrust plate 541b and the lower end surface of the sleeve 542a are opposed to each other through a minuscule gap therebetween in the direction along the rotational axis. In these minuscule gaps in the direction along the rotational axis, a dynamic pressure generating fluid is interposed to make up the thrust dynamic bearing 545. Further, the upper end surface of the sleeve housing 542c is formed with a thrust dynamic pressure generating groove 547a to promote the generation of the thrust dynamic pressure. Also, the lower end surface of the sleeve 542a is formed with a thrust dynamic pressure generating groove 547b to promote the generation of the thrust dynamic pressure. These two thrust dynamic bearings 545a, 545b generate vertically opposite thrust dynamic pressures and support the load in the direction along the rotational axis.

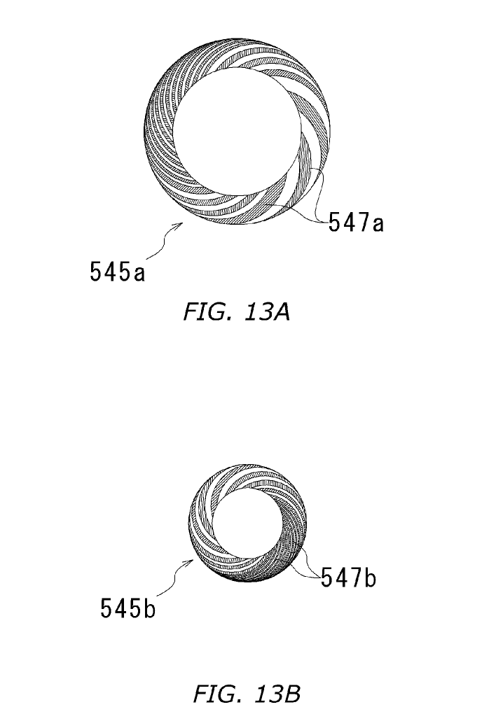

FIGS. 13A, 13B show the shapes of the thrust dynamic pressure generating grooves 547 of the upper and lower thrust dynamic bearings 545, respectively, according to this embodiment. In this embodiment, both the upper and lower thrust dynamic pressure generating grooves 547a are spiral in shape, and the dynamic pressure generating grooves 547 of the upper thrust dynamic bearing 545a are formed in what is called the pump-in shape to feed the dynamic pressure generating fluid diametrically inward by the rotation of the shaft 541. The thrust dynamic pressure generating grooves 547b of the lower thrust dynamic pressure bearing 545b also have what is called the pump-in shape to send the dynamic pressure generating fluid diametrically inward by the rotation of the shaft 541.

According to this embodiment, a lubricant is used as the dynamic pressure generating fluid. Depending on the conditions for rotation or the bearing structure, however, the dynamic pressure generating fluid may be formed of air, a gas, a gel or grease.

(6-4) Opposite Moment

According to this embodiment, the rotary member support center point 543 represents the center of the dynamic pressure generated by the radial dynamic bearing 544 and the thrust dynamic bearing 545, and is located at substantially the intermediate point of a pair of radial dynamic bearings in the direction along the rotational axis.

The thrust dynamic pressure generating grooves 547 have spiral grooves of varied thickness along the peripheral direction. The upper thrust dynamic pressure grooves 547a, as shown in FIG. 13A, are progressively increased in thickness rightward and progressively reduced in thickness leftward in FIG. 9. The lower thrust dynamic pressure generating grooves 547b, on the other hand, as shown in FIG. 13B, are progressively narrowed rightward and increased in thickness leftward as viewed in FIG. 9. The portion of thin grooves has an increased number of thrust dynamic pressure generating grooves 547 for a higher dynamic pressure. In the portion with thick grooves, on the other hand, the number of the thrust dynamic pressure generating grooves 547 is reduced thereby to weaken the dynamic pressure.

In the upper thrust dynamic bearing 545a, therefore, the dynamic pressure is increased on the left side but not substantially on the right side as viewed in FIG. 9. The upper thrust dynamic bearing 545a is located above the rotary member support center point 543, and therefore the dynamic pressure generated by the upper thrust dynamic bearing 545a generates a moment to turn the shaft 541 constituting the rotary axis clockwise around the rotary member support center point 543.

In the lower thrust dynamic bearing 545b, on the other hand, the dynamic pressure on the right side as viewed in FIG. 9 is increased, but not substantially on the left side. The lower thrust dynamic bearing 545b is located under the rotary member support center point 543, and therefore the dynamic pressure generated by the lower thrust dynamic bearing 545b generates a moment to turn the shaft 541 constituting the rotary axis clockwise around the rotary member support center point 543.

In this way, both the upper and lower thrust dynamic bearings 545 are supplied with a clockwise moment around the rotational axis.

(6-5) Operation

The moment generated by the head 415 described in (6-2) and the moment generated by the dynamic pressure due to the upper and lower thrust dynamic bearings 545a, 545b are opposed to each other thereby to offset part of the moment generated by the head 415.

(6-6) Effects

According to this embodiment, like in the first embodiment, a moment as large as 15 to 32 g·mm is generated by the head 413, the head arm 414 supporting the head 413 and the head suspension 416. By changing the thickness along the peripheral direction of the thrust dynamic pressure generating grooves 547a, 547b, however, a moment is generated to offset the moment imposed by the head. In this way, the load due to the moment generated by the head 413 can be reduced considerably. This structure imposes a predetermined thrust dynamic pressure and therefore stabilizes the rotation. Also, in view of the fact that the moment load to be supported by the bearing is reduced, the rigidity required of the bearing is not greatly increased and therefore the bearing loss is prevented from being considerably increased.

### Seventh Embodiment

(7-1) Configuration of Recording Disk and Spindle Motor

The recording disk driving apparatus 601 and the spindle motor 602 according to this embodiment are substantially similar to the recording disk driving apparatus 401 and the spindle motor 402, respectively, according to the fifth embodiment, although the bearing mechanism 604 according to this embodiment is different from the bearing mechanism 404 according to the fifth embodiment.

(7-2) Moment Generated By Head

This embodiment has a similar longitudinal sectional view to the fifth embodiment, as shown in FIG. 9. The pressure imposed on the recording disk 412 by the head suspension 415 generates a counterclockwise moment as viewed in FIG. 9 around the rotary member support center point 643. As a result, the rotational axis is tilted in an angular positive direction as viewed in FIG. 9.

(7-3) Bearing Structure

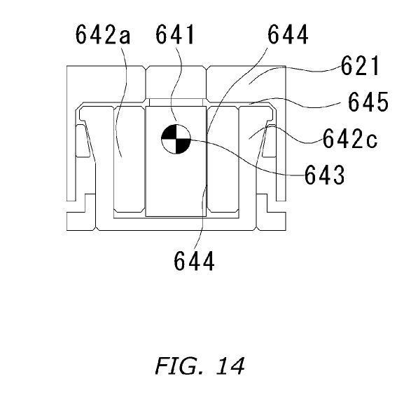

FIG. 14 is a longitudinal sectional view showing a bearing mechanism 604 according to this embodiment. The bearing mechanism 604 according to this embodiment includes a sleeve housing 642c fixed on a base plate 422, a sleeve 642a and a shaft 641 fixed integrally with the rotor hub 621. The sleeve 642a has a cylindrical inner peripheral surface making up a bearing hole. The shaft 641 has a cylindrical outer peripheral surface and is fitted in the bearing hole through a diametrically minuscule gap. A dynamic pressure generating fluid is interposed in the diametrical gap formed between the outer peripheral surface of the shaft 641 and the inner peripheral surface of the sleeve 642a thereby to make up a radial dynamic bearing 644. Further, the inner peripheral surface of the sleeve 642a is formed with a pair of radial dynamic pressure generating grooves 646 in spaced relation to each other in the direction along the rotational axis thereby to promote the generation of the radial dynamic pressure at two points in the direction along the rotational axis.

The upper end of the sleeve housing 642c is in opposed relation to the lower flat surface of the rotor hub 621 through a minuscule gap in the direction along the rotational axis. A thrust dynamic pressure generating fluid is interposed in the minuscule gap in the direction along the rotational axis thereby to make up the thrust dynamic bearing 645. Further, the upper end surface of the sleeve housing 642c is formed with a thrust dynamic pressure generating groove 647 to promote the generation of the thrust dynamic pressure. The thrust dynamic bearing 445 generates the thrust dynamic pressure in such a direction as to raise the rotor hub 621 afloat upward and support the load in the direction along the rotational axis.

According to this embodiment, the thrust dynamic pressure generating groove 647 is spirally formed in what is called the pump-in structure in which the dynamic pressure generating fluid is fed diametrically inward by the rotation of the shaft 641.

According to this embodiment, a lubricant is used as the dynamic pressure generating fluid. Depending on the conditions for rotation or the bearing structure, however, air, a gas, a gel or grease may alternatively be used as the dynamic pressure generating fluid.

(7-4) Opposite Moments

According to this embodiment, the rotary member support center point 643 constitutes the center of the dynamic pressure generated by the radial dynamic bearing 644 and the thrust dynamic bearing 645. The rotary member support center point 643 is located slightly below the upper radial dynamic bearing 644 in the direction along the rotational axis.

The minuscule gap forming the thrust dynamic bearing 645 in the direction along the rotational axis is changed along the peripheral direction. The gap in the direction along the rotational axis is narrowed on the left side and widened on the right side as viewed in FIG. 9. In the portion having a narrow gap in the direction along the rotational axis, the pressure is increased due to a higher static pressure as well as the dynamic pressure generating effect of the thrust dynamic pressure generating groove 647. In the portion having a wide gap in the direction along the rotational axis, on the other hand, the dynamic pressure generated by the thrust dynamic pressure generating groove 647 is scattered into the bearing space due to the wide bearing gap and therefore the pressure is not increased.

In the thrust dynamic bearing 645, therefore, the pressure is increased on the left side, while the pressure is not increased on the right side as viewed in FIG. 9. The thrust dynamic bearing 645 is located above the rotary member support center point 643 and therefore generates a moment for turning the shaft 641 constituting the rotational axis clockwise around the rotary member support center point 643.

(7-5) Operation

The moment generated by the head 415 described in (7-1) and the moment generated by the thrust dynamic bearing 645 described in (7-4) are opposed to each other thereby to offset part of the moment generated by the head 415.

(7-6) Effects

According to this embodiment, like in the first embodiment, a moment as large as 15 to 32 g·mm is generated by the head 413, the head arm 414 for supporting the head 413 and the head suspension 416. Nevertheless, the minuscule gap making up the thrust dynamic bearing 645 in the direction along the rotational axis is changed along the peripheral direction, so that a moment is generated in such a direction as to offset the moment generated by the head 413. In this way, the load due to the moment generated by the head 413 can be reduced considerably. With this structure, a predetermined thrust dynamic pressure is imposed, and therefore the rotation is stabilized. In addition, the moment load to be supported by the bearing is reduced. Therefore, the rigidity required for the bearing is not greatly increased, and the bearing loss is prevented from being increased to a sizable degree.

### Other Embodiments

The embodiments of the invention can be variously modified without departing from the spirit and scope of the invention. The diameter of the recording disk and the number of disks, for example, can be appropriately determined in accordance with the intended applications.

The bearing mechanism according to the first to fourth embodiments can use the ball bearing instead of the dynamic bearing. With the ball bearing, the load of the moment in one direction in which the rotational axis is to be tilted is reduced thereby to reduce the uneven wear of the ball bearing. Even in the case where the ball bearing is used, it is needless to say that the rotary member support center point can be defined in the same manner as otherwise.

Whether the spindle motor is the inner rotor or the outer rotor type has no effect on the embodiment according to the invention. Further, the number of magnetic pole teeth of the stator and the shape of the rotor magnet should be appropriately selected and changed according to the specification to be satisfied.

A single instead of a pair of radial dynamic bearings can be used. As another alternative, what is called the hybrid bearing including the radial bearing and the ball bearing combined can be employed.

Also, the thrust dynamic bearing may be formed with herringbone grooves, stepped grooves or other shape of grooves instead of spiral grooves.

Further, according to the embodiments, both the thrust dynamic bearing and the radial dynamic bearing are not necessarily formed, but a conical type of bearing equally applies. The conical type of bearing has the dual function of the thrust dynamic bearing and the radial dynamic bearing, and finds a suitable application with a compact apparatus. The conical-type dynamic bearing is configured of a cone member having a conical outer peripheral surface formed on the shaft and a sleeve having a conical inner peripheral surface parallel to the conical outer peripheral surface. One of the outer peripheral surface of the cone member and the inner peripheral surface of the sleeve is formed with a dynamic pressure generating groove, and a lubricating fluid is held in the gap formed between the outer peripheral surface of the cone member and the inner peripheral surface of the sleeve thereby to form a conical type of dynamic bearing.

Further, the thrust direction may be supported by what is called the pivot bearing which in turn is supported in point contact with a sliding member. Furthermore, the dynamic bearing may use a dynamic pressure generating fluid such as liquid fats or other high polymer compounds, or any of various gases, compressed gases and air. Especially in applications with a high rotational speed, the reduction in bearing loss is a crucial problem to be tackled and can be achieved conspicuously according to the invention. In the gas bearing, on the other hand, a high bearing rigidity cannot be obtained easily. From this point of view, it is needless to say that a great effect can be produced by embodying this invention. On the other hand, the fats have a high viscosity as compared with air and is liable to cause a large bearing loss. To cope with this problem, the invention is also applicable suitably.

As described above, modifications of the invention are included in the appended claims without departing from the spirit and scope of the invention.

What is claimed is:

1. A recording disk driving apparatus comprising:
a spindle motor including a rotary member, a rotor magnet and a bearing mechanism, wherein the rotary member has a rotor hub, a recording disk fixed to an outer peripheral surface of the rotor hub and a rotor magnet mounted on the rotor hub, a stationary member has a stator arranged in opposed relation to the rotor magnet, and the bearing mechanism for rotatably supporting the rotary member with respect to the stationary member about a rotational axis;
an information access means including a head arranged on a recording surface of the recording disk for reading and/or writing information on the recording disk and a head arm for supporting the head, moving to an arbitrary position on the recording disk and pressing the head against the recording disk;
a bias means for generating a moment to tilt the rotational axis of the rotary member in one direction; and
a housing for accommodating the recording disk, the spindle motor, the information access means and the bias means; wherein
the head is arranged only on one surface of the recording disk,
a pressure imposed by the information access means to press the head against the recording disk generates a pressure moment to tilt the rotational axis of the rotary member, and
at least a part of the pressure moment is offset by the moment generated by the bias means.

2. A recording disk driving apparatus according to claim 1, wherein:
the stator includes a plurality of radially extending magnetic pole teeth wound with coils;
the bias means includes the rotor magnet and the magnetic pole teeth;
a magnetic force of interaction between the rotor magnet; and
the magnetic pole teeth of the stator is applied unevenly in a predetermined peripheral direction of the rotor magnet thereby to generate a bias force.

3. A recording disk driving apparatus according to claim 2, wherein:
an end portion of the magnetic pole teeth in opposed relation to a peripheral surface of the rotor magnet is formed in a shape making up a part of the cylindrical surface along the peripheral surface of the rotor magnet; and
an area of the surface of each of the magnetic pole teeth in opposed relation to the rotor magnet is changed along the peripheral direction thereby to generate the bias force.

4. A recording disk driving apparatus according to claim 2, wherein a distance between the peripheral surface of the rotor magnet, and an end portion of the magnetic pole teeth in opposed relation to a peripheral surface of the rotor magnet is changed along the peripheral direction thereby to generate the bias force.

5. A recording disk driving apparatus according to claim 2, wherein a number of turns of the coil wound on the magnetic pole teeth is changed in accordance with a phase of peripheral arrangement thereby to generate the bias force.

6. A recording disk driving apparatus according to claim 2, wherein an angular interval between the magnetic pole teeth is changed in accordance with a phase of peripheral arrangement thereby to generate the bias force.

7. A recording disk driving apparatus according to claim 1, wherein:
at least a part of the stationary member in opposed relation to the rotor magnet in a direction along the rotational axis is formed of a ferromagnetic material;
the bias means includes the rotor magnet and a fixing member, and a magnetic attraction force generated in the direction along the rotational axis by the rotor magnet; and
the fixing member is changed along a peripheral direction of rotation of the rotor magnet thereby to generate a bias force.

8. A recording disk driving apparatus according to claim 7, wherein:
the part of the stationary member makes up a base member of the spindle motor constituting a part of the housing;
the base member is formed of the ferromagnetic material;
an end portion of the rotor magnet in the direction along the rotational axis is in opposed relation to the base member;
a peripheral part of the base member is formed with one selected from a hole, and a concave portion or a convex portion; and
the magnetic attraction force between the base member and the rotor magnet is changed along the peripheral direction thereby to generate the bias force.

9. A recording disk driving apparatus according to claim 8, wherein:
the stator includes a plurality of radially extending magnetic pole teeth wound with coils;
the part of the base member in opposed relation to the coils is formed with a plurality of coil relief holes in advance;
a coil relief hole arranged along the peripheral direction is extended to a position in opposed relation to the end portion of the rotor magnet in the direction along the rotational axis; and
the magnetic attraction force between the base member and the rotor magnet is changed along the peripheral direction thereby to generate the bias force.

10. A recording disk driving apparatus according to claim 7, wherein:
the stationary member includes a thrust yoke of the ferromagnetic material formed on the part in opposed relation to an axial end portion of the rotor magnet;
a peripheral part of the thrust yoke is formed with one selected from a notch and a hole, or one selected from a concave portion and a convex portion;
the magnetic attraction force between the thrust yoke fixed on the base member; and
the rotor magnet is applied unevenly along the peripheral direction thereby to generate the bias force.

11. A recording disk driving apparatus comprising:
a spindle motor including a rotary member, a rotor magnet and a bearing mechanism, wherein the rotary member has a rotor hub, a recording disk fixed to an outer peripheral surface of the rotor hub and a rotor magnet mounted on the rotor hub, a stationary member having a stator arranged in opposed relation to the rotor magnet, and a bearing mechanism for rotatably supporting the rotary member with respect to the stationary member about a rotational axis;
an information access means including a head arranged on a recording surface of the recording disk for reading and/or writing information on a recording disk and a head arm for supporting the head, moving to an arbitrary position on the recording disk and pressing the head against the recording disk;
a bias means for generating a moment to tilt the rotational axis of the rotary member in one direction; and
a housing for accommodating the recording disk, the spindle motor, the information access means and the bias means; wherein
the information access means includes the head arm having the head at an end thereof and an arm support mechanism with an other end of the head arm mounted thereon for rotatably supporting the head arm,
the arm support mechanism is mounted on the housing by an arm support mechanism mounting portion arranged on the housing, and an angle between a line segment connecting the arm support mechanism mounting portion and a rotational center of the rotary member on the one hand, and selected one of the direction of the moment in which the rotational axis is tilted by the bias means and the direction 180 degrees symmetric with respect to the direction of the moment about the rotational center on the other hand is set at between 60 degrees and 120 degrees not inclusive,
the head is arranged only on one surface of the recording disk,
the pressure imposed by the information access means to press the head against the recording disk generates a pressure moment to tilt the rotational axis of the rotary member, and
at least a part of the pressure moment is offset by the moment generated by the bias means.

12. A recording disk driving apparatus according to claim 11, wherein:
the stator includes a plurality of radially extending magnetic pole teeth wound with coils;
the bias means includes the rotor magnet and the magnetic pole teeth;
a magnetic force of interaction between the rotor magnet; and
the magnetic pole teeth of the stator is applied unevenly in a predetermined peripheral direction of the rotor magnet thereby to generate a bias force.

13. A recording disk driving apparatus according to claim 12, wherein:
an end portion of the magnetic pole teeth in opposed relation to a peripheral surface of the rotor magnet is formed in such a shape as to constitute a part of the cylindrical surface along the peripheral surface of the rotor magnet; and
an area of the surface of each of the magnetic pole teeth in opposed relation to the rotor magnet is changed along the peripheral direction thereby to generate the bias force.

14. A recording disk driving apparatus according to claim 12, wherein a distance between the peripheral surface of the rotor magnet, and an end portion of the magnetic pole teeth in opposed relation to a peripheral surface of the rotor magnet is changed along the peripheral direction thereby to generate the bias force.

15. A recording disk driving apparatus according to claim 12, wherein a number of turns of the coil wound on the magnetic pole teeth is changed in accordance with a phase of peripheral arrangement thereby to generate the bias force.

16. A recording disk driving apparatus according to claim 12, wherein an angular interval between the magnetic pole teeth is changed in accordance with a phase of peripheral arrangement thereby to generate the bias force.

17. A recording disk driving apparatus according to claim 11, wherein:
at least a part of the stationary member in opposed relation to the rotor magnet in a direction along the rotational axis is formed of a ferromagnetic material;
the bias means includes the rotor magnet and a fixing member; and
a magnetic attraction force generated in the direction along the rotational axis by the rotor magnet and the fixing member is changed along a peripheral direction of rotation of the rotor magnet thereby to generate the bias force.

18. A recording disk driving apparatus according to claim 17, wherein:
the part of the stationary member makes up a base member of the spindle motor constituting a part of the housing;
the base member is formed of the ferromagnetic material;
an end portion of the rotor magnet in the direction along the rotational axis is in opposed relation to the base member;
a peripheral part of the base member is formed with one selected from a hole, and a concave portion or a convex portion; and
the magnetic attraction force between the base member and the rotor magnet is changed along the peripheral direction thereby to generate the bias force.

19. A recording disk driving apparatus according to claim 18, wherein:
the stator includes a plurality of radially extending magnetic pole teeth wound with coils;
the part of the base member in opposed relation to the coils is formed with a plurality of coil relief holes in advance;
a coil relief hole arranged along the peripheral direction is extended to a position in opposed relation to the end portion of the rotor magnet in the direction along the rotational axis; and
the magnetic attraction force between the base member and the rotor magnet is changed along the peripheral direction thereby to generate the bias force.

20. A recording disk driving apparatus according to claim 17, wherein:
the stationary member includes a thrust yoke of the ferromagnetic material formed on the part in opposed relation to an axial end portion of the rotor magnet;
a peripheral part of the thrust yoke is formed with one selected from a notch and a hole, or one selected from a concave portion and a convex portion; and
the magnetic attraction force between the thrust yoke fixed on the base member and the rotor magnet is applied unevenly along the peripheral direction thereby to generate the bias force.

21. A spindle motor with a base plate, the spindle motor incorporated into a hard disk drive having a recording disk, an information access means and a housing, wherein the information access means includes a head arranged on the recording surface of the recording disk for reading and/or writing information on the recording disk and a head arm for supporting the head, moving to an arbitrary position on the recording disk and pressing the head against the recording disk, the spindle motor including a rotary member, a rotor magnet and a bearing mechanism, wherein the rotary member has a rotor hub having an outer peripheral surface on which the recording disk is to be mounted and a rotor magnet mounted on the rotor hub, a stationary member having a stator arranged in opposed relation to the rotor magnet, and a bearing mechanism for rotatably supporting the rotary member with respect to the stationary member about a rotational axis, and comprising:
a bias means for generating a moment to tilt the rotational axis of the rotary member in one direction; and
the base plate on which the spindle motor, the bias means are mounted; wherein
the base plate has an arm support mechanism mounting portion on which an arm support mechanism is to be mounted for rotatably supporting the head arm, and
an angle between a line segment connecting the arm support mechanism mounting portion and a rotational center of the rotary member on the one hand, and one selected from the direction in which the rotational axis of the rotary member is tilted by the moment of the bias means and the direction 180 degrees symmetric with the tilting direction about the rotational center on the other hand, is set at between 60 degrees and 120 degrees not inclusive.

22. A spindle motor with a base plate according to claim 21, wherein:
the stator includes a plurality of radially extending magnetic pole teeth wound with coils;
the bias means includes the rotor magnet and the magnetic pole teeth;
a magnetic force of interaction between the rotor magnet; and
the magnetic pole teeth of the stator is applied unevenly in a predetermined peripheral direction of rotation of the rotor magnet thereby to generate a bias force.

23. A spindle motor with a base plate according to claim 22, wherein:
an end portion of the magnetic pole teeth in opposed relation to a peripheral surface of the rotor magnet is formed in such a shape as to constitute a part of the cylindrical surface along the peripheral surface of the rotor magnet; and
an area of the surface of each of the magnetic pole teeth in opposed relation to the rotor magnet is changed along the peripheral direction thereby to generate the bias force.

24. A spindle motor with a base plate according to claim 22, wherein:
a distance between the peripheral surface of the rotor magnet; and
an end portion of the magnetic pole teeth in opposed relation to a peripheral surface of the rotor magnet is changed along the peripheral direction thereby to generate the bias force.

25. A spindle motor with a base plate according to claim 22, wherein a number of turns of the coil wound on the magnetic pole teeth is changed in accordance with a phase of peripheral arrangement thereby to generate the bias force.

26. A spindle motor with a base plate according to claim 22, wherein an angular interval between the magnetic pole teeth is changed in accordance with a phase of peripheral arrangement thereby to generate the bias force.

27. A spindle motor with a base plate according to claim 21, wherein:
at least a part of the stationary member in opposed relation to the rotor magnet in a direction along the rotational axis is formed of a ferromagnetic material;
the bias means includes the rotor magnet and a fixing member;
a magnetic attraction force generated in the direction along the rotational axis by the rotor magnet; and
the fixing member is changed along a peripheral direction of rotation of the rotor magnet thereby to generate a bias force.

28. A spindle motor with a base plate according to claim 27, wherein:
the part of the stationary member makes up a base member of the spindle motor constituting a part of the housing;
the base member is formed of the ferromagnetic material;
an end portion of the rotor magnet in the direction along the rotational axis is in opposed relation to the base member;
a peripheral part of the base member is formed with one selected from a hole, a concave portion or a convex portion; and
the magnetic attraction force between the base member and the rotor magnet is changed along the peripheral direction thereby to generate the bias force.

29. A spindle motor with a base plate according to claim 28, wherein:
the stator includes a plurality of radially extending magnetic pole teeth wound with coils;
the part of the base member in opposed relation to the coils is formed with a plurality of coil relief holes in advance;
a coil relief hole arranged along the peripheral direction is extended to a position in opposed relation to the end portion of the rotor magnet in the direction along the rotational axis;
and the magnetic attraction force between the base member and the rotor magnet is changed along the peripheral direction thereby to generate the bias force.

30. A spindle motor with a base plate according to claim 27, wherein:
the stationary member includes a thrust yoke of the ferromagnetic material formed on the part in opposed relation to an axial end portion of the rotor magnet;
a peripheral part of the thrust yoke is formed with one selected from a notch, and a hole, or one selected from a concave portion and a convex portion; and
the magnetic attraction force between the thrust yoke fixed on the base member and the rotor magnet is applied unevenly along the peripheral direction thereby to generate the bias force.
